(19) United States
(12) Patent Application Publication
(10) Pub. No.: US 2026/0148304 A1
(43) Pub. Date: May 28, 2026

(54) SENTIMENT ANALYSIS AND CUSTOMER REVIEW USER INTERFACE

(71) Applicant: NCR Voyix Corporation, Atlanta, GA (US)

(72) Inventors: Daniel Thomas Woods, Peachtree Corners, GA (US); Nicholas Paul Chaloult, Perry, GA (US); Ke Zhang, Duluth, GA (US); Saad Ahmed, Johns Creek, GA (US); Manan Yogesh Patel, Kennesaw, GA (US)

(21) Appl. No.: 18/963,187

(22) Filed: Nov. 27, 2024

(51) Int. Cl. G06Q 40/06; G06F 40/20; G06Q 30/0282

(52) U.S. Cl. CPC G06Q 40/06; G06F 40/20; G06Q 30/0282

(57) ABSTRACT

System and techniques may be used for sentiment analysis of restaurant reviews. An example technique may include collecting data from a plurality of sources, the collected data including customer reviews corresponding to a restaurant, and categorizing each of the customer reviews in the collected data as positive, neutral, or negative related to an aspect of the restaurant. The example technique may include outputting an alert to a device of a stakeholder of the restaurant in response to determining that a customer review of the customer reviews has been categorized as negative.

### BACKGROUND

Customer reviews of restaurants provide valuable insights into customer experiences, often influencing future customers. These reviews typically include subjective evaluations of food quality, service, ambiance, or value for money. Some reviews may be accompanied by a star ratings or other scoring metric.

Natural Language Processing (NLP) is a field of artificial intelligence focused on enabling computers to understand, interpret, and respond to human language. It may involve techniques like sentiment analysis, text classification, or language generation to derive meaningful insights from unstructured text data.

### SUMMARY

In various embodiments, methods and systems are disclosed for sentiment analysis of restaurant reviews.

According to an embodiment, a technique may include collecting data from a plurality of sources, the collected data including customer reviews corresponding to a restaurant, and categorizing each of the customer reviews in the collected data as positive, neutral, or negative related to an aspect of the restaurant. The technique may include outputting an alert to a device of a stakeholder of the restaurant in response to determining that a customer review of the customer reviews has been categorized as negative.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system for real-time sentiment analysis of customer feedback in accordance with some examples.

FIG. 2 illustrates a user interface for presenting customer feedback including recommended corrective actions in accordance with some examples.

FIG. 3 illustrates an architecture diagram for customer feedback sentiment analysis and notification in accordance with some examples.

FIG. 4 illustrates technical layers for collecting customer feedback and generating a user interface in accordance with some examples.

FIG. 5 illustrates a machine learning engine for training and execution related to determining sentiment of customer reviews in accordance with some examples.

FIG. 6 illustrates generally a flowchart showing a technique for sentiment analysis of restaurant reviews in accordance with some examples.

FIG. 7 illustrates generally an example of a block diagram of a machine upon which any one or more of the techniques discussed herein may perform in accordance with some embodiments.

### DETAILED DESCRIPTION

Systems, methods, techniques, and methodologies described herein may be used for sentiment analysis of restaurant reviews. Restaurants often struggle to keep up with the constant flow of customer feedback on multiple platforms, such as in-app reviews, social media reviews, or third-party review sites. Manually tracking and analyzing this feedback is time-consuming and prone to errors, making it difficult for owners to stay on top of customer satisfaction and address concerns promptly. Without timely insight into customer opinions, restaurant owners risk losing business due to unresolved issues or overlooked opportunities for improvement. The systems and techniques described herein solve this and other problems by automating collection of reviews and providing feedback, for example real-time analysis of customer reviews. Restaurant owners may be provided with a pattern as it develops, an assessment of overall satisfaction, or a proposed response to a customer concern.

The systems and techniques described herein provide an automated feedback management tool designed to help restaurant owners effectively monitor and respond to customer reviews across multiple platforms. Feedback by customers may be scraped automatically from various sources, such as in-app reviews, social media, or public review sites. Customer comments scraped may be consolidated into a website or dashboard for easy access by a restaurant stakeholder. The systems and techniques described herein use advanced sentiment analysis, and may categorize reviews as positive, neutral or negative, allowing restaurant owners to gauge overall customer satisfaction quickly. In some examples, a topic analysis may be performed, for example grouping feedback into a most relevant theme, or providing a sentiment score for a theme.

For real-time responsiveness, the systems and techniques described herein may send an alert to a stakeholder, for example directing the stakeholder to a dashboard. The alert may occur whenever negative feedback or recurring issues are detected, such as delayed service or poor customer interactions. The alert notification ensures that restaurant stakeholders may address problems promptly, minimizing potential damage to reputation. The information about customer reviews may be presented in a dashboard, such as a user friendly reporting interface integrated seamlessly into an already existing website, such as a restaurant management website. Insights on the dashboard may be presented, including trends over time, commonly used keywords, or a breakdown of customer sentiment. In some examples, feedback patterns may be analyzed to suggest an improvement based on frequent complaints.

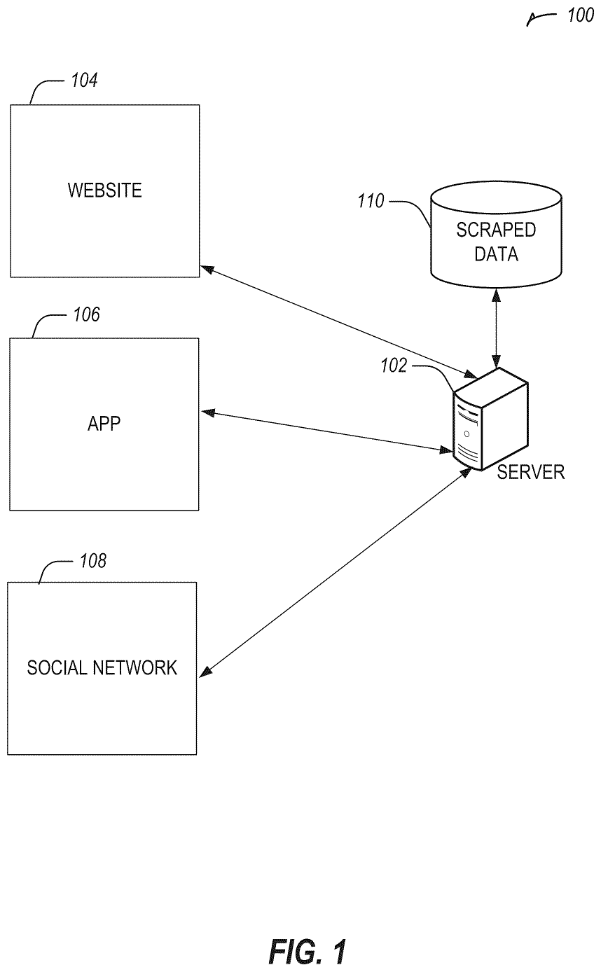

FIG. 1 illustrates a system 100 for real-time sentiment analysis of customer feedback in accordance with some examples. The system includes a server 102 (e.g., to run a scrapper), which may scrape various sources, such as a website, app, social media, etc. As described herein “scraping” or use of a “scraper” may include using an application programming interface (API) request or other technique for retrieving data from a public or private source. Example sources website 104, app 106, and social network 108 are shown in FIG. 1. After scrapping the data, the server 102 may store the scrapped data in a database 110, which may be separate from the server 102, part of the server 102, or the like.

The server 102 may perform an automated sentiment analysis on scrapped data. The scraped data may be scrapped across multiple platforms, for example the app 106 may be an app of the restaurant, a booking app, a review app, etc. The social network 108 may be a general social network that includes open data, or may include a restaurant-specific page or dedicated area (e.g., sub-channel). The website 104 may include a review site, a restaurant-specific site, a booking site, a travel site, etc. The data may be scraped periodically, such as once an hour, once a minute, once a day, etc. or in response to a request (e.g., a stakeholder of the restaurant logging into a management or administrative site, such as a dashboard). The server 102 may perform a sentiment analysis on the scrapped data and categorize reviews as positive, negative, or neutral. In some examples, the server 102 may condense a list of reviews into relevant topics or themes, for display. The server 102 may issue an alert, which may include a real-time alert (e.g., within five minutes of identifying a sentiment or trend) and output the alert to notify a stakeholder of the restaurant that a negative review has occurred or an identified trend has occurred, such as recurring issue, poor service, negative press, etc. The alert may be output from the server 102 via text, email, automated voice call, etc.

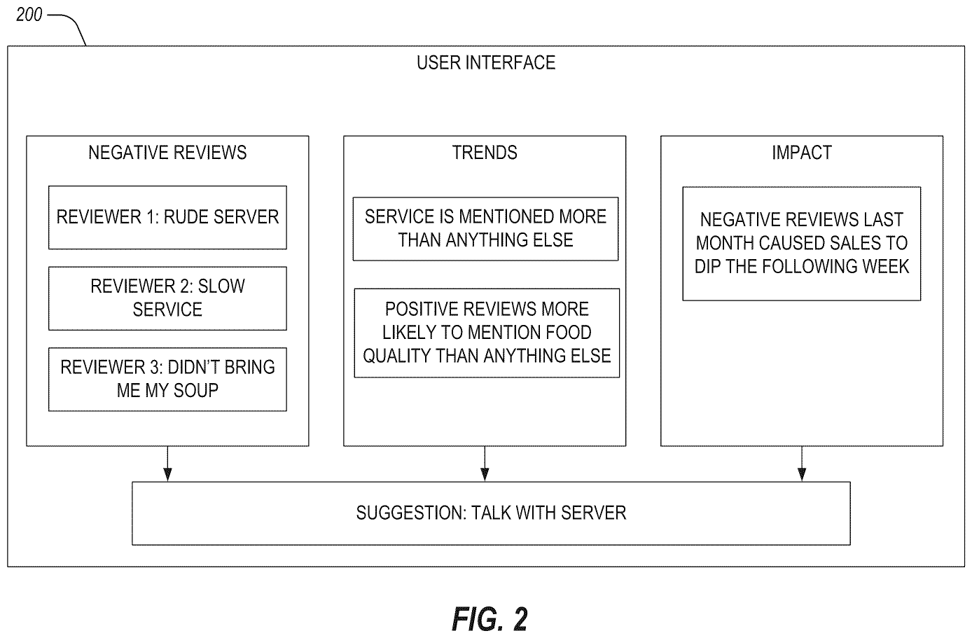

FIG. 2 illustrates a user interface 200 for presenting customer feedback including recommended corrective actions for a restaurant in accordance with some examples. The user interface 200 shows an example of reviews, trends, and an impact. The user interface 200 includes example negative revies, such as “rude server,” “slow service,” and “didn't bring me my soup.” These reviews, when input to a machine learning trained model, may be used to indicate a suggestion, such as the one shown in the user interface 200, “talk with server.” The negative reviews indicate some issue with service, and a stakeholder of the restaurant may wish to discuss with the server what happened or what may be done to remedy these issues so that they do not continue in the future.

The user interface 200 indicates one or more trends in scraped reviews (not necessarily just those in the negative reviews, although trends for a category of reviews such as negative may be used). The trends shown in user interface 200 include “service is mentioned more than anything else,” which may indicate good or bad service, but that service drives reviewers to comment, so it is important that the restaurant maintain a high level of service. The trends also include “positive reviews more likely to mention food quality than anything else,” which may suggest to the stakeholder of the restaurant that their food quality is excellent, and they should focus any remedial actions on service.

The user interface 200 includes an impact, which may be a past impact, a predicted future impact, a current impact (e.g., large numbers of reviews are being posted on a social network causing the restaurant to be “trending” or visible within the social network, which may be positive or negative). The example in the user interface 200 is a negative past impact, indicating that “negative reviews last month caused sales to dip the following week.” This impact provides the stakeholder of the restaurant with an incentive to act on the suggestion based on the review or trends. While the suggestion is shown as being a result of each of the negative reviews, trends, and impact, the suggestion may be generated from a combination of any two or a single factor. Multiple suggestions may be provided, in some examples. An example suggestion may include a suggested response to a review (e.g., an apology to a negative review). For example, to reviewer 1 from the negative reviews, a suggestion may be presented on the user interface 200 to reply to the review, “We apologize for the rude service. Please come back, mention this review, and we would be happy to give you a free appetizer.”

The user interface 200 may be customized by the stakeholder of the restaurant, for example with what reviews to display (e.g., only negative, a mix of positive and negative, etc.), what trends to display (e.g., to show only trends that result in an action suggestion, only new trends, etc.), whether to show current, past, or future predicted impacts, or the like. The arrangement of the reviews, trends, impact, suggestions, etc. may be changed according to the preferences of the stakeholder of the restaurant. In some examples, the user interface 200 may preset current customer sentiment trends and historical data, for comparison.

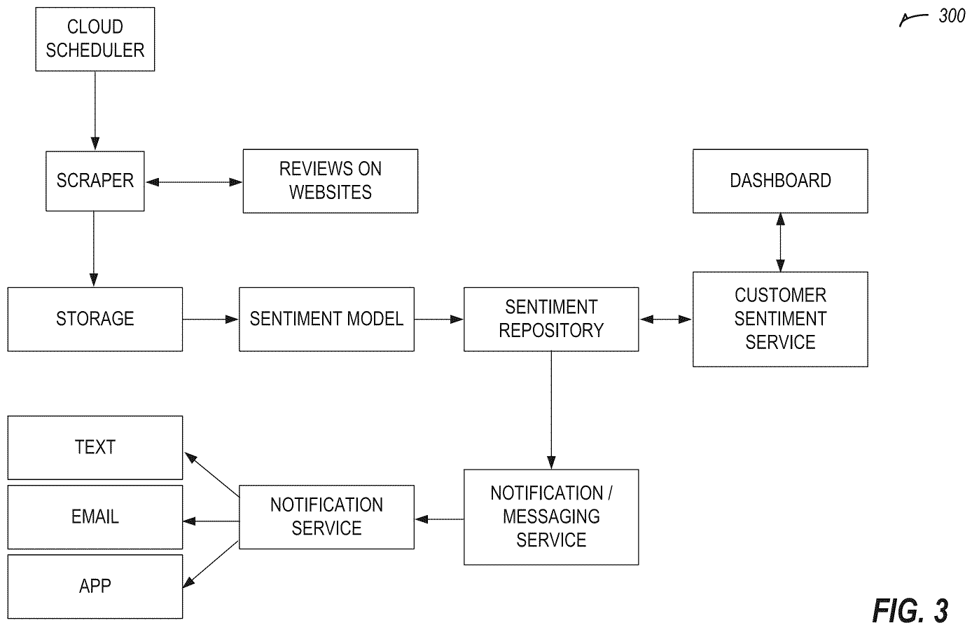

FIG. 3 illustrates an architecture diagram 300 for customer feedback sentiment analysis and notification in accordance with some examples. The architecture diagram 300 shows an example data flow. A cloud scheduler may initiate scraping by a scraper of various review sources (e.g., websites, apps, social media, etc.). The scraper may visit websites or other sources to obtain review data, which may be sent for storage. A sentiment model may generate a sentiment for each review (or a subset of reviews), which may be stored in a sentiment repository. The sentiment repository may send the sentiment to a customer sentiment service (e.g., with the review) for display on a dashboard. A restaurant stakeholder may not be currently or frequently viewing the dashboard. A notification may be sent to the stakeholder to notify that there is a new sentiment, trend, impact, review, etc. to review on the dashboard. The sentiment repository may send an indication to a notification/messaging service, which may create a message to send to a notification service. The notification service may send a notification via text, email, an app, a voice call, etc. to the stakeholder.

In an example, the cloud scheduler may run periodically (e.g., daily, weekly, hourly, monthly, etc.) or on demand, triggering the scraper. Once scraped, the reviews are stored in a cloud storage bucket, triggering a second function that runs sentiment analysis using a natural language API. After analyzing the reviews, the sentiment scores or identified topics may be written to a database collection. A trigger may call a backend to run a heuristic on the results. When feedback is flagged for urgent attention, a notification may be sent to a stakeholder, guiding the stakeholder to a user interface displaying trends or customer sentiment.

After clicking a notification link, a stakeholder may be directed to a feedback analysis dashboard, which may display current or historical data. The stakeholder may select a custom date range. One or more visualizations may be displayed on the dashboard, such as a pie chart that depicts distribution of positive, negative, and neutral reviews, a bar graph that highlights a set of most prevalent themes or their correlated sentiment, or the like. The dashboard may display a data grid including a set of most relevant reviews for a theme, or a line chart that allows a stakeholder to select a specific topic to track how sentiment for the topic has changed over time. These tools provide a clear, detailed view of customer feedback, enabling a stakeholder to identify trends and insights at a glance.

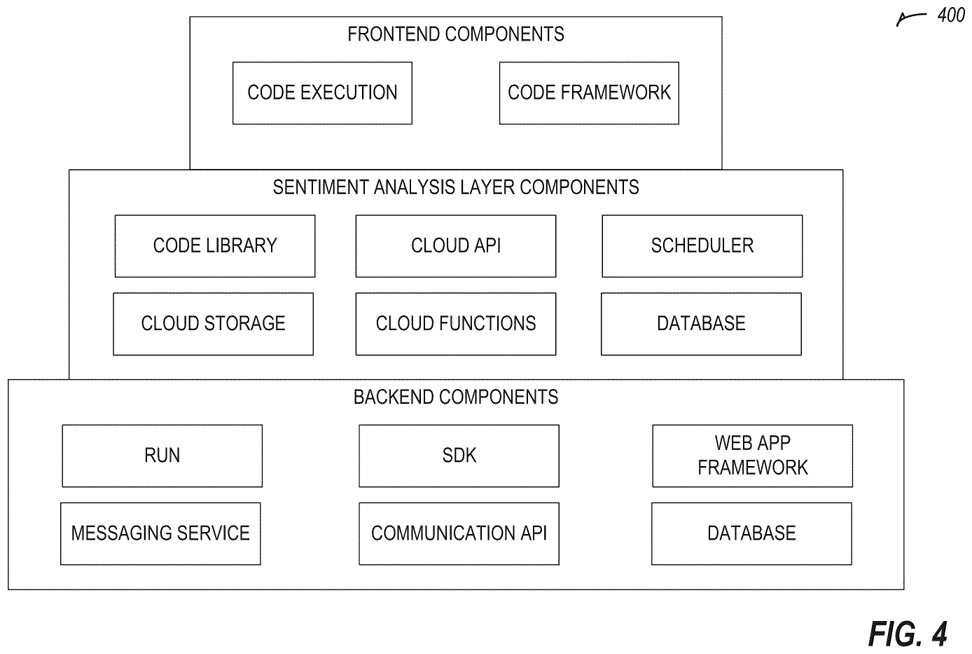

FIG. 4 illustrates a block diagram 400 showing technical layers for collecting customer feedback and generating a user interface in accordance with some examples. The block diagram 400 includes a set of frontend components, a set of sentiment analysis layer components, and a set of backend components. The frontend components may be used to generate a dashboard for a user interface, for example using a code framework component and a code execution component. The sentiment analysis layer components may be used to generate a sentiment for a user review, for example using a code library, cloud storage, a cloud API, a cloud functions component, a scheduler, and a database. The backend components may be used to obtain user reviews, such as from a website, or to generate a communication to send to a restaurant stakeholder. The backend components include a run component, a messaging service, a software development kit (SDK), a communication API, a web app framework, and a database (which may be the same database as the one in the sentiment analysis layer components, in some examples).

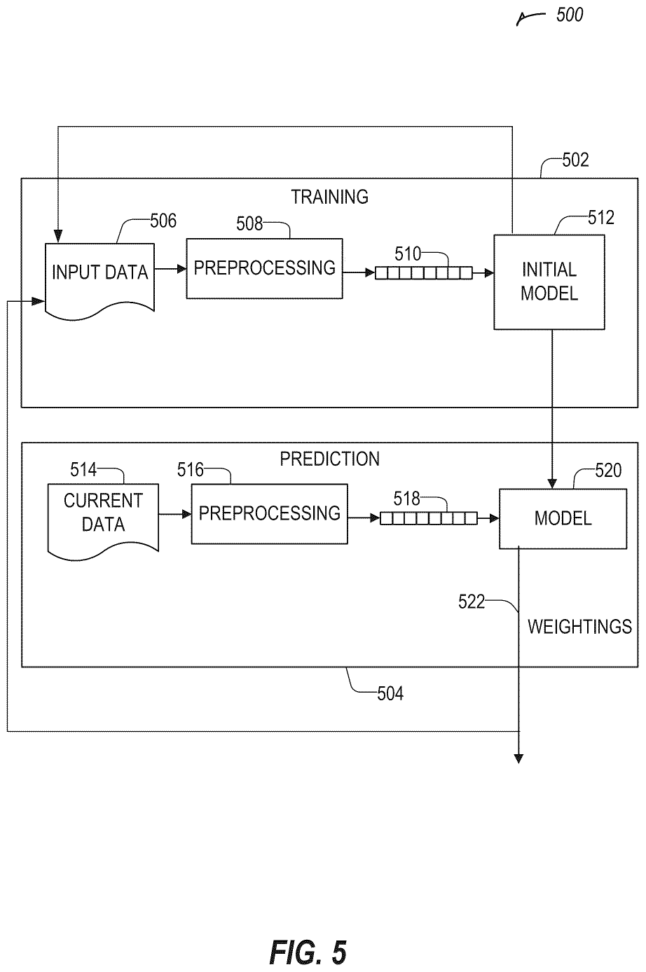

FIG. 5 illustrates a machine learning engine for training and execution related to sentiment analysis of restaurant reviews.

The machine learning engine may be deployed to execute at a mobile device (e.g., a cell phone, a tablet, etc.) or a computer (e.g., a desktop, a laptop, etc.). FIG. 5 shows an example machine learning engine 500 according to some examples of the present disclosure.

Machine learning engine 500 uses a training engine 502 and a prediction engine 504. Training engine 502 uses input data 506, for example after undergoing preprocessing component 508, to determine one or more features 510. The one or more features 510 may be used to generate an initial model 512, which may be updated iteratively or with future labeled or unlabeled data (e.g., during reinforcement learning), for example to improve the performance of the prediction engine 504 or the initial model 512. An improved model may be redeployed for use.

The input data 506 may include data from a scrapper, customer reviews, metadata about customers, locations of reviews (e.g., websites), etc.

In the prediction engine 504, current data 514 (e.g., two items in a pair) may be input to preprocessing component 516. In some examples, preprocessing component 516 and preprocessing component 508 are the same. The prediction engine 504 produces feature vector 518 from the preprocessed current data, which is input into the model 520 to generate one or more criteria weightings 522. The criteria weightings 522 may be used to output a prediction, as discussed further below.

The training engine 502 may operate in an offline manner to train the model 520 (e.g., on a server). The prediction engine 504 may be designed to operate in an online manner (e.g., in real-time, at a mobile device, on a wearable device, etc.). In some examples, the model 520 may be periodically updated via additional training (e.g., via updated input data 506 or based on labeled or unlabeled data output in the weightings 522) or based on identified future data, such as by using reinforcement learning to personalize a general model (e.g., the initial model 512) to a particular user.

Labels for the input data 506 may include whether a review is positive, negative, or neutral. In some examples, labels may be generated by natural language processing or a large language model (LLM).

The initial model 512 may be updated using further input data 506 until a satisfactory model 520 is generated. The model 520 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 502 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 502. In an example embodiment, a regression model is used and the model 520 is a vector of coefficients corresponding to a learned importance for each of the features in the vector of features 510, 518. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

A language model may include a large language model (LLM), a natural language processing (NLP) model, or the like. Large Language Models (LLMs) are advanced artificial intelligence systems trained on vast amounts of text data to understand and generate human-like language. These models use deep learning techniques, particularly transformer architectures, to process and produce coherent and contextually relevant text across a wide range of topics and tasks. A NLP model is a model that analyzes and processes text data to translate, perform sentiment analysis, or generate text based on context.

Once trained, the model 520 may output a prediction, such as a sentiment of a review, including positive, negative, or neutral, an emotional label (e.g., angry, happy, etc.), an indication of why a label is applied to a particular review, a recommendation for addressing a review or set of reviews, a trend, an impact, or the like.

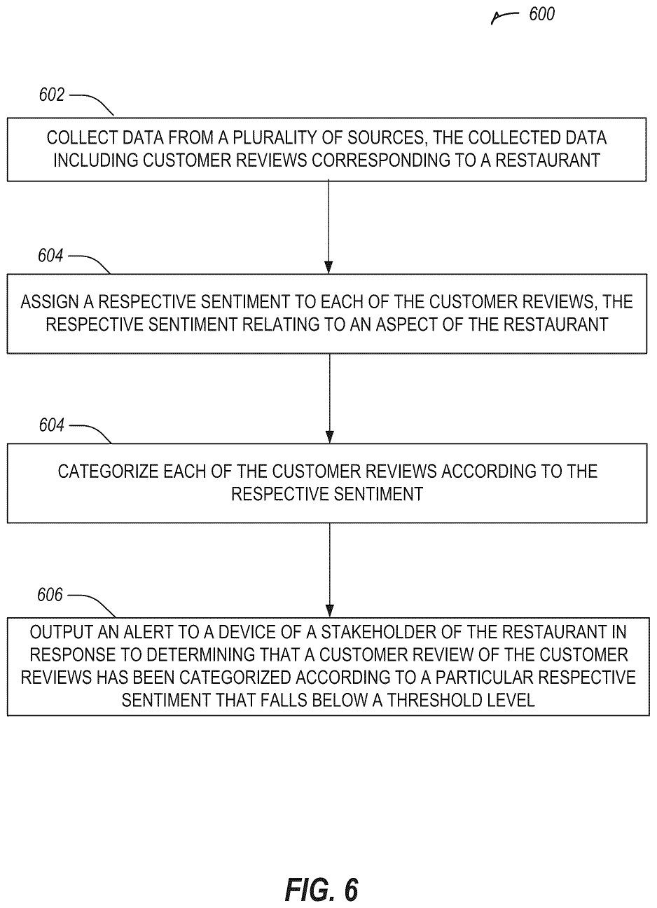

FIG. 6 illustrates generally a flowchart showing a technique 600 for sentiment analysis of restaurant reviews in accordance with some examples.

The technique 600 includes an operation 602 to collect data from a plurality of sources, the collected data including customer reviews corresponding to a restaurant. The collected data may be collected from two or more review websites, the two or more review websites presenting data in different formats (e.g., text only, image only, including video, including image and text, including audio, or any combination thereof). The collected data may include data from a plurality of restaurants in a chain, the plurality of restaurants including the restaurant.

The technique 600 includes an operation 604 to assign a respective sentiment to each of the customer reviews, the respective sentiment relating to an aspect of the restaurant. Operation 604 may include determining a sentiment score for each of the customer reviews.

The technique 600 includes an operation 606 to categorize each of the customer reviews according to the respective sentiment. Operation 606 may include applying a label of positive, neutral, or negative.

The technique 600 includes an operation 608 to output an alert to a device of a stakeholder of the restaurant in response to determining that a customer review of the customer reviews has been categorized according to a particular respective sentiment that falls below a threshold level. The alert may be generated based on a trend identified from the customer reviews over time, the trend corresponding to a change in a count of the customer reviews that are negative or positive. The alert may include an indication of a suggested improvement for addressing a negative sentiment in the customer reviews. Operation 606 may include outputting the alert in response to determining that categorizing each of the customer reviews indicates a threshold number of reviews were categorized to be positive, neutral, or negative, the threshold being specific to the stakeholder or the restaurant. Operation 606 may include outputting the alert within a timeframe of a particular customer review being posted to a website, the timeframe being specific to the stakeholder or the restaurant.

The collected data may be collected periodically, for example being categorized in response to being collected, and in some examples, outputting the alert occurs automatically without receiving a request to categorize the collected data. The technique 600 may include before categorizing each of the customer reviews, using natural language processing to create embeddings for text in the customer reviews. In an example, the technique 600 includes consolidating the collected data for display on a single webpage, and wherein the alert, when selected on the device of the stakeholder, directs the device to the single webpage. In this example, the technique 600 may include wherein the single webpage is further configured to display inventory, employee scheduling, and sales reports for the restaurant.

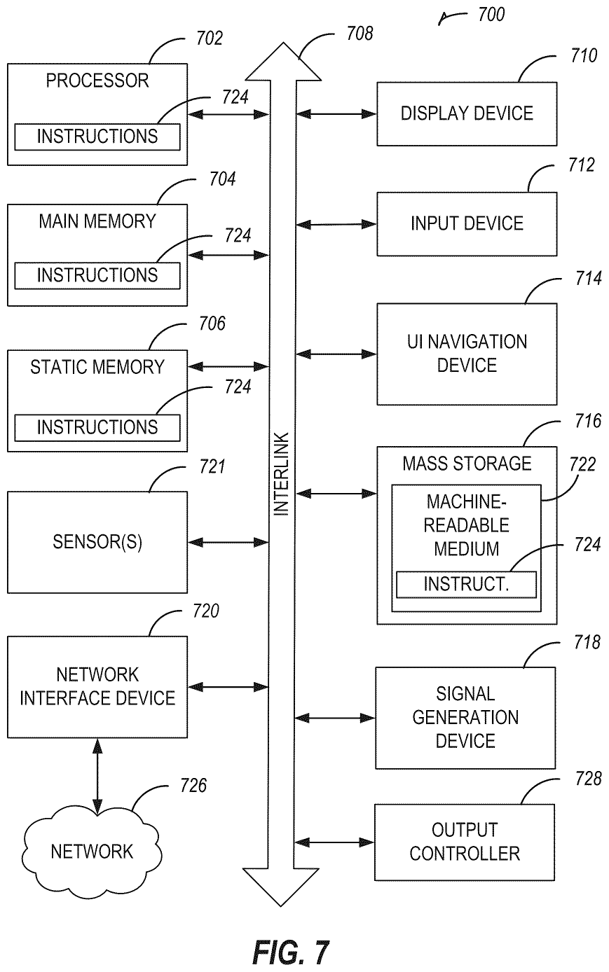

FIG. 7 illustrates generally an example of a block diagram of a machine 700 upon which any one or more of the techniques discussed herein may perform in accordance with some examples. In alternative examples, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

Each of these non-limiting examples may stand on its own, or may be combined in various permutations or combinations with one or more of the other examples.

Example 1 is a method comprising: collecting data from a plurality of sources, the collected data including customer reviews corresponding to a restaurant; assigning a respective sentiment to each of the customer reviews, the respective sentiment relating to an aspect of the restaurant; categorizing each of the customer reviews according to the respective sentiment; and outputting an alert to a device of a stakeholder of the restaurant in response to determining that a customer review of the customer reviews has been categorized according to a particular respective sentiment that falls below a threshold level.

In Example 2, the subject matter of Example 1 includes, wherein the alert is generated based on a trend identified from the customer reviews over time, the trend corresponding to a change in a count of the customer reviews that are negative or positive.

In Example 3, the subject matter of Examples 1-2 includes, wherein categorizing each of the customer reviews includes determining a sentiment score for each of the customer reviews.

In Example 4, the subject matter of Examples 1-3 includes, consolidating the collected data for display on a single webpage, and wherein the alert, when selected on the device of the stakeholder, directs the device to the single webpage.

In Example 5, the subject matter of Examples 1-4 includes, wherein categorizing includes applying a label of positive, neutral, or negative.

In Example 6, the subject matter of Examples 1-5 includes, wherein the alert includes an indication of a suggested improvement for addressing a negative sentiment in the customer reviews.

In Example 7, the subject matter of Examples 1-6 includes, wherein the collected data is collected from two or more review websites, the two or more review websites presenting data in different formats.

In Example 8, the subject matter of Examples 1-7 includes, wherein outputting the alert includes outputting the alert in response to determining that categorizing each of the customer reviews indicates a threshold number of reviews were categorized to be positive, neutral, or negative, the threshold being specific to the stakeholder or the restaurant.

In Example 9, the subject matter of Examples 1-8 includes, before categorizing each of the customer reviews, using natural language processing to create embeddings for text in the customer reviews.

In Example 10, the subject matter of Examples 1-9 includes, wherein the collected data includes data from a plurality of restaurants in a chain, the plurality of restaurants including the restaurant.

In Example 11, the subject matter of Examples 1-10 includes, wherein the collected data is collected periodically, wherein the collected data is categorized in response to being collected, and wherein outputting the alert occurs automatically without receiving a request to categorize the collected data.

In Example 12, the subject matter of Examples 1 -11 includes, wherein outputting the alert includes outputting the alert within a timeframe of a particular customer review being posted to a website, the timeframe being specific to the stakeholder or the restaurant.

Example 13 is at least one machine-readable medium including instructions, which when executed by processing circuitry, causes the processing circuitry to perform operations comprising: collecting data from a plurality of sources, the collected data including customer reviews corresponding to a restaurant; assigning a respective sentiment to each of the customer reviews, the respective sentiment relating to an aspect of the restaurant; categorizing each of the customer reviews according to the respective sentiment; and outputting an alert to a device of a stakeholder of the restaurant in response to determining that a customer review of the customer reviews has been categorized according to a particular respective sentiment that falls below a threshold level.

In Example 14, the subject matter of Example 13 includes, wherein the alert is generated based on a trend identified from the customer reviews over time, the trend corresponding to a change in a count of the customer reviews that are negative or positive.

In Example 15, the subject matter of Examples 13-14 includes, wherein categorizing each of the customer reviews includes determining a sentiment score for each of the customer reviews.

In Example 16, the subject matter of Examples 13-15 includes, consolidating the collected data for display on a single webpage, and wherein the alert, when selected on the device of the stakeholder, directs the device to the single webpage.

In Example 17, the subject matter of Example 16 includes, wherein the single webpage is further configured to display inventory, employee scheduling, and sales reports for the restaurant.

In Example 18, the subject matter of Examples 13-17 includes, wherein the alert includes an indication of a suggested improvement for addressing a negative sentiment in the customer reviews.

In Example 19, the subject matter of Examples 13-18 includes, wherein categorizing includes applying a label of positive, neutral, or negative.

Example 20 is a system comprising: processing circuitry; and memory, including instructions, which when executed by the processing circuitry, cause the processing circuitry to perform operations comprising: collecting data from a plurality of sources, the collected data including customer reviews corresponding to a restaurant; assigning a respective sentiment to each of the customer reviews, the respective sentiment relating to an aspect of the restaurant; categorizing each of the customer reviews according to the respective sentiment; and outputting an alert to a device of a stakeholder of the restaurant in response to determining that a customer review of the customer reviews has been categorized according to a particular respective sentiment that falls below a threshold level.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
collecting data from a plurality of sources, the collected data including customer reviews corresponding to a restaurant;
assigning a respective sentiment to each of the customer reviews, the respective sentiment relating to an aspect of the restaurant;
categorizing each of the customer reviews according to the respective sentiment; and
outputting an alert to a device of a stakeholder of the restaurant in response to determining that a customer review of the customer reviews has been categorized according to a particular respective sentiment that falls below a threshold level.

2. The method of claim 1, wherein the alert is generated based on a trend identified from the customer reviews over time, the trend corresponding to a change in a count of the customer reviews that are negative or positive.

3. The method of claim 1, wherein categorizing each of the customer reviews includes determining a sentiment score for each of the customer reviews.

4. The method of claim 1, further comprising consolidating the collected data for display on a single webpage, and wherein the alert, when selected on the device of the stakeholder, directs the device to the single webpage.

5. The method of claim 1, wherein categorizing includes applying a label of positive, neutral, or negative.

6. The method of claim 1, wherein the alert includes an indication of a suggested improvement for addressing a negative sentiment in the customer reviews.

7. The method of claim 1, wherein the collected data is collected from two or more review websites, the two or more review websites presenting data in different formats.

8. The method of claim 1, wherein outputting the alert includes outputting the alert in response to determining that categorizing each of the customer reviews indicates a threshold number of reviews were categorized to be positive, neutral, or negative, the threshold being specific to the stakeholder or the restaurant.

9. The method of claim 1, further comprising, before categorizing each of the customer reviews, using natural language processing to create embeddings for text in the customer reviews.

10. The method of claim 1, wherein the collected data includes data from a plurality of restaurants in a chain, the plurality of restaurants including the restaurant.

11. The method of claim 1, wherein the collected data is collected periodically, wherein the collected data is categorized in response to being collected, and wherein outputting the alert occurs automatically without receiving a request to categorize the collected data.

12. The method of claim 1, wherein outputting the alert includes outputting the alert within a timeframe of a particular customer review being posted to a website, the timeframe being specific to the stakeholder or the restaurant.

13. At least one machine-readable medium including instructions, which when executed by processing circuitry, causes the processing circuitry to perform operations comprising:
collecting data from a plurality of sources, the collected data including customer reviews corresponding to a restaurant;
assigning a respective sentiment to each of the customer reviews, the respective sentiment relating to an aspect of the restaurant;
categorizing each of the customer reviews according to the respective sentiment; and
outputting an alert to a device of a stakeholder of the restaurant in response to determining that a customer review of the customer reviews has been categorized according to a particular respective sentiment that falls below a threshold level.

14. The at least one machine-readable medium of claim 13, wherein the alert is generated based on a trend identified from the customer reviews over time, the trend corresponding to a change in a count of the customer reviews that are negative or positive.

15. The at least one machine-readable medium of claim 13, wherein categorizing each of the customer reviews includes determining a sentiment score for each of the customer reviews.

16. The at least one machine-readable medium of claim 13, further comprising consolidating the collected data for display on a single webpage, and wherein the alert, when selected on the device of the stakeholder, directs the device to the single webpage.

17. The at least one machine-readable medium of claim 16, wherein the single webpage is further configured to display inventory, employee scheduling, and sales reports for the restaurant.

18. The at least one machine-readable medium of claim 13, wherein the alert includes an indication of a suggested improvement for addressing a negative sentiment in the customer reviews.

19. The at least one machine-readable medium of claim 13, wherein categorizing includes applying a label of positive, neutral, or negative.

20. A system comprising:
processing circuitry; and
memory, including instructions, which when executed by the processing circuitry, cause the processing circuitry to perform operations comprising:
collecting data from a plurality of sources, the collected data including customer reviews corresponding to a restaurant;
assigning a respective sentiment to each of the customer reviews, the respective sentiment relating to an aspect of the restaurant;
categorizing each of the customer reviews according to the respective sentiment; and
outputting an alert to a device of a stakeholder of the restaurant in response to determining that a customer review of the customer reviews has been categorized according to a particular respective sentiment that falls below a threshold level.
